(19) United States
(12) Patent Application Publication
(10) Pub. No.: US 2009/0141912 A1
(43) Pub. Date: Jun. 4, 2009

(54) Object sound extraction apparatus and object sound extraction method

(75) Inventor: Takashi Hiekata, Kobe-shi (JP)

Correspondence Address: REED SMITH LLP, 3110 FAIRVIEW PARK DRIVE, SUITE 1400, FALLS CHURCH, VA, 22042, US

(73) Assignee: Kabushiki Kaisha Kobe Seiko Sho

(21) Appl. No.: 12/292,272

(22) Filed: Nov. 14, 2008

(30) Foreign Application Priority Data
Nov. 30, 2007 (JP) 2007-310452

(51) Int. Cl. H04R 3/00

(52) U.S. Cl. 381/122

(57) ABSTRACT

In an object sound extraction apparatus, one or more reference sound separation signals corresponding to one or more reference sounds other than an object sound are separated and generated on the basis of a main acoustic signal and one or more sub acoustic signals. A signal level of the reference sound separation signal is detected. When the detected signal level is within a predetermined range, a frequency spectrum of a reference sound corresponding signal is compressed and corrected at a large compression ratio as the detected signal level becomes small, and the frequency spectrum of the reference sound corresponding signal obtained by the compression and correction is subtracted from a frequency spectrum of an object sound corresponding signal corresponding to the main acoustic signal. The acoustic signal corresponding to the object sound is extracted from the object sound corresponding signal and the acoustic signal is outputted.

### BACKGROUND OF THE INVENTION

1. Field of the Invention

The present invention relates to an object sound extraction apparatus and an object sound extraction method for extracting an acoustic signal corresponding to an object sound from a predetermined object sound source on the basis of acoustic signals obtained via microphones, and outputting the extracted acoustic signal.

2. Description of the Related Art

In devices that have a function to input sound generated by sound sources such as speakers, for example, audio conference systems, video conference systems, ticket-vending machines, and car navigation systems, a sound (hereinafter, referred to as object sound) generated by a certain sound source (hereinafter, referred to as object sound source) is collected by an acoustic input section (hereinafter, referred to as microphone). Depending on environments the sound source exists, an acoustic signal obtained via the microphone contains noise components other than an acoustic signal component corresponding to the object sound. If a ratio of the noise components in the acoustic signal obtained via the microphone is high, clarity of the object sound is lost, and quality in telephone call and automatic voice recognition rates are decreased.

Conventionally, it has been known a two-input spectrum subtraction processing that uses a main microphone (voice microphone) in which a voice (an example of the object sound) generated by a speaker is mainly inputted, and a sub microphone (noise microphone) in which noises around the speaker are mainly inputted (the voice of the speaker is substantially not inputted). In the processing, noise signals based on acoustic signals obtained via the sub microphone are removed from an acoustic signal obtained via the main microphone. The two-input spectrum subtraction processing extracts (that is, removes the noise components) the acoustic signal corresponding to the voice (the object sound) generated by the speaker using a subtraction processing of time-series characteristic vectors of individual signals inputted from the main microphone and the sub microphone.

Meanwhile, it has been known a noise removing device that uses a plurality of sub microphones (noise microphones). In the device, the two-input spectrum subtraction processing is performed with respect to acoustic signals inputted via each sub microphone based on, depending on situations, an acoustic signal selected from the acoustic signals, or a synthetic signal that is weighted and averaged by a predetermined weight, and an acoustic signal inputted via the main microphone. By the noise removing device, even in an acoustic space where nonstationary noise that changes temporal and spatial characteristics is generated, effective noise removal can be performed.

Further, it has been known a technology that obtains an extraction signal of an object sound by removing a signal that is generated by processing an acoustic signal obtained via a microphone (corresponding to the above-described sub microphone) that mainly inputs a reference sound (non-object sound) other than an object sound using an adaptive filter from an acoustic signal (hereinafter, referred to as main acoustic signal) obtained via a microphone (corresponding to the above-described main microphone) that mainly inputs an object sound, and adjusts the adaptive filter so that the power of the extraction signal is minimized.

Meanwhile, in a case where a plurality of sound sources and a plurality of microphones (sound input sections) exist in a predetermined acoustic space, in each of the microphones, an acoustic signal (hereinafter, referred to as mixed acoustic signal) in which individual acoustic signals (hereinafter, referred to as sound source signals) from each of the sound sources are superimposed is inputted. The method that identifies (separates) each sound source signal using only the mixed acoustic signals that are inputted as described above is called a blind source separation method (hereinafter, referred to as BSS method).

Further, one of sound source separation processings of the BSS method, there is a sound source separation processing based on an independent component analysis (hereinafter, referred to as ICA). In the BSS method based on the ICA, by using the fact that each of the sound source signals is statistically independent each other in the mixed acoustic signals inputted via the microphones, a predetermined separation matrix (inverse mixed matrix) is optimized. To the inputted mixed acoustic signals, filter processing using the optimized separation matrix is performed to identify (separate sound sources) the sound source signals. In the processing, the optimization of the separation matrix is performed using an identified (separated) signal (separated signal) identified by a filter processing using a separation matrix set at a certain time, by calculating a separation matrix which is subsequently used in sequential calculation (learning calculation).

In the sound source separation processing based on the ICA-BASS method, each separated signal is outputted via each output end (also referred to as output channel). The number of the output ends is the same as the number of inputs (the number of microphones) of the mixed acoustic signals.

Further, as the sound source separation processing, a sound source separation processing based on a binary masking processing (an example of binaural signal processing) has been known. The binary masking processing is a sound source separation processing that can be realized at a relatively low operation load performed by comparing levels (powers) in each of frequency components (frequency bins) divided in a plurality of components between mixed sound signals inputted via a plurality of directional microphones to remove signal components other than sound signals from main sound sources of each mixed sound signal.

Meanwhile, to remove noises, if various signal processings (processings performed on a signal) are performed on a frequency spectrum of an acoustic signal, a harsh musical noise (artificial noise) is generated in the processed acoustic signal. If the acoustic level (volume) of the acoustic signal containing the musical noise reaches an audible level of humans, even if the acoustic level is low, the acoustic signal gives a very uncomfortable feeling to the audience. Accordingly, in devices for performing a signal processing on an acoustic signal to output a sound to be heard by humans such as hearing aids, hearing instruments, and cell phones, it is very important not to generate the musical noise in the signal-processed acoustic signal (output signal) as much as possible.

For example, it has been known a technology to reduce a musical noise, in which, a noise section in an acoustic signal is estimated and a frequency spectrum in a noise signal estimated from a signal in the noise section is subtracted from a frequency spectrum of the original acoustic signal, and a signal level is attenuated by changing gains for each noise section.

However, in the known arts, if the object sound is mixed in at a relatively large volume with respect to the sub microphones, a component of an acoustic signal corresponding to the object sound can be considered as a noise component, and mistakenly removed. Accordingly, it is not possible to obtain a high noise removal performance.

Further, if a synthetic signal obtained by weighting and averaging sound signals inputted via the sub microphones (noise microphones) by a predetermined weight is used as an input signal used in the two-input spectrum subtraction processing, depending on changes in acoustic environments, mismatches between the weight in the weighted average and degrees of mix of the object sounds in each of the sub microphones occur, and the noise removal performance is decreased.

Further, if the signal selected from the plurality of acoustic signals inputted via the sub microphones (noise microphones) is used as an input signal in the two-input spectrum subtraction processing, under a condition different noises arrive at each microphone from the plurality of directions, noise components due to acoustic signals that are not selected are not removed. Accordingly, the noise removal performance is decreased.

If, on the basis of the main acoustic signal and the sub acoustic signals, the sound source separation processing based on the BSS method based on the ICA or the binary masking processing is performed, a separated signal corresponding to the object sound can be obtained. However, depending on acoustic environments, signal components of noises other than the object sound are contained in the separated signal at a relatively high rate. For example, in the sound source separation processing based on the BSS method based on the ICA, under an environment that the number of the sound sources of the object sound and the other noises is larger than the number of the microphones, or the noises are reflected or echoed, the sound source separation performance is decreased.

Further, on a separation signal (acoustic signal) corresponding to an object sound obtained by a sound source separation processing, if a signal processing for removing signal components of noises other than the object sound is performed, a musical noise is generated in the signal-processed acoustic signal. The musical noise gives a very uncomfortable feeling to the audience.

Further, in the musical noise reduction technologies, it is necessary to accurately estimate a noise section in an acoustic signal. However, in a case where a level of a background noise in the acoustic signal to be processed is high, or many kinds of background noises exist, the accurate estimation of the noise section is not easy, and it is difficult to obtain an adequate noise removing performance.

### SUMMARY OF THE INVENTION

Accordingly, the present invention has been made in view of the above, and an object of the present invention is to provide an object sound extraction apparatus and an object sound extraction method capable of faithfully extracting (reproducing) an acoustic signal corresponding to an object sound as much as possible (that is, non-object sound removing performance is high) under an environment where the object sound and the other noises (non-object sounds) are mixed in acoustic signals obtained via microphones and the mixed conditions can be varied. Further, in the extracted signal, a musical noise that gives an uncomfortable feeling to the audience can be reduced.

To achieve the above object, in an object sound extraction apparatus according to an aspect of the present invention, on the basis of a main acoustic signal obtained via a main sound input section (main microphone) that mainly inputs a sound (hereinafter, referred to as object sound) outputted from a predetermined object sound source (certain sound source), and one or more sub acoustic signals other than the object sound obtained via one or more sub sound input sections (sub microphones that are disposed at positions different from a position of the main microphone, or microphones that have directivities in directions different from a directivity of the main microphone), extracts an acoustic signal corresponding to the object sound and outputs the acoustic signal. The object sound extraction apparatus includes structural elements described in the following (1-1) to (1-3).
(1-1) A sound source separation section for performing a sound source separation processing for separating and generating one or more reference sound separation signals corresponding to one or more reference sounds (also referred to as noise sound or non-object sound) other than the object sound on the basis of the main acoustic signal and the one or more sub acoustic signals.
(1-2) A signal level detection section for detecting a signal level of the reference sound separation signal or a reference sound corresponding signal that is a synthesis signal obtained by synthesizing the reference sound separation signals.
(1-3) A spectrum subtraction processing section for extracting an acoustic signal corresponding to the object sound from an object sound corresponding signal and outputting the acoustic signal when the detected signal level by the signal level detection section is within a predetermined range by compressing and correcting a frequency spectrum of the reference sound corresponding signal at a large compression ratio as the detected signal level becomes small, and subtracting the frequency spectrum of the reference sound corresponding signal obtained by the compression and correction from a frequency spectrum of the main acoustic signal or the object sound corresponding signal obtained by performing a predetermined signal processing on the main acoustic signal.

The compression ration is a ratio of a signal value before the compression and correction to a signal value after the compression.

The object sound extraction apparatus according to the aspect of the present invention can further include a structural element described in the following (1-4).
(1-4) An object sound corresponding signal outputting section for outputting the object sound corresponding signal as an acoustic signal corresponding to the object sound when the detected signal level is at a level less than a predetermined lower limit level.

In such a case, the spectrum subtraction processing section outputs a signal obtained by the frequency spectrum subtraction processing as an acoustic signal corresponding to the object sound when the detected signal level is at the lower limit level or more.

The sound source separation section can perform a sound source separation processing based on a blind source separation method based on an independent component analysis (FDICA method described below) performed on an acoustic signal in a frequency domain.

In the aspect of the present invention, the object sound corresponding signal contains signal components of the object sound as main components. However, depending on the position of the object sound source or noise generation environments to the microphones (the main microphone and the sub microphones), in the object sound corresponding signal, a relatively large amount of signal components of the noise sounds other than the object sound may remain.

Meanwhile, the reference sound corresponding signals obtained by the processing in the sound source separation section contain, as main components, signal components of sounds (sounds (reference sounds) other than the object sound) from noise sound sources in sound collection ranges of the individual sub microphones that are disposed at different positions and have different directivities.

If the components of the noise sounds (reference sounds) other than the object sound are contained in the object sound separation signals, by the frequency spectrum subtraction processing performed by the spectrum subtraction processing section, most of the signal components of the noise sounds (reference sounds) other than the object sound can be removed from the object sound corresponding signal. Further, the extraction signal formed by the spectrum subtraction processing section is a signal formed, even in an environment where different noises (reference sounds) from a plurality of directions arrive at the main microphone, by removing entire signal components of the reference sound separation signals corresponding to each of the noises.

In the spectrum subtraction processing, the frequency spectrum to be subtracted from the frequency spectrum of the object sound corresponding signal is formed, to the frequency spectrum of the reference sound corresponding signal, by performing the compression and correction at a large compression ratio as the level (volume) of the reference sound corresponding signal becomes small. Accordingly, in the aspect of the present invention, when the level of the reference sound corresponding signal is high (that is, the volume of the noise sound is large), the signal component annoying the audience is actively removed form the object sound corresponding signal, and the acoustic signal corresponding to the object sound can be faithfully extracted as much as possible. As a result of the processing, the extraction signal (acoustic signal corresponding to the object sound) may contain some musical noises. However, as compared to a state where the signal component of the noise sound remains, the acoustic signal is friendlier to the audience. Further, in the aspect of the present invention, when the level of the reference sound corresponding signal is low, (that is, the volume of the noise sound is small), the processing to remove the signal component form the object sound corresponding signal is not actively performed. By the processing, the musical noise annoying the audience can be reduced. As a result of the processing, the acoustic signal corresponding to the object sound may contain some signal components of the noise sound. However, the signal level (sound volume) is small and the audience hardly notices the noise sound. That is, in the aspect of the present invention, when the volume of the noise sound is large, the removal of the signal component of the noise sound is prioritized. When the volume of the noise sound is small, the reduction of the musical noise is given priority to the removal of the signal component of the musical noise.

Accordingly, in the aspect of the present invention, in the state where a specific noise sound (non-object sound) or a plurality of noise sounds that exist in different directions arrive at the main microphone at a relatively high level, an acoustic signal corresponding to an object sound can be faithfully extracted (reproduced) as much as possible and a musical noise annoying the audience can be reduced.

Further, as specific processings performed by the individual sections in the object sound extraction apparatus in the aspect of the present invention, combinations of the processings described in the following (1-5) to (1-7) can be provided.
(1-5) The sound source separation section performs a sound source separation processing for separating and generating an object sound separation signal corresponding to the object sound and the reference sound separation signals on the basis of combinations of the main acoustic signal and the individual sub acoustic signals.
(1-6) The signal level detection section detects signal levels of the individual reference sound separation signals.
(1-7) The spectrum subtraction processing section performs the compression and correction on the individual reference sound separation signals, and subtracts frequency spectrums obtained by performing the compression and correction on the individual reference sound corresponding signals from a frequency spectrum of the object sound corresponding signal obtained by synthesizing the object sound separation signals.

Further, as specific processings performed by the individual sections in the object sound extraction apparatus in the aspect of the present invention, combinations of the processings described in the following (1-8) to (1-10) can be provided.
(1-8) The sound source separation section performs a sound source separation processing for separating and generating an object sound separation signal corresponding to the object sound and the reference sound separation signals on the basis of combinations of the main acoustic signal and the individual sub acoustic signals.
(1-9) The signal level detection section detects a signal level of the reference sound corresponding signal obtained by synthesizing the reference sound separation signals.
(1-10) The spectrum subtraction processing section subtracts a frequency spectrum obtained by performing the compression and correction on the reference sound corresponding signal obtained by synthesizing the reference sound separation signals from a frequency spectrum of the object sound corresponding signal obtained by synthesizing the object sound separation signals.

Further, in the aspect of the present invention, the signal level detection by the signal level detection section and the compression and correction by the sound source separation section can be performed for individual sections in predetermined frequency bands.

By the processing, the compression and correction can be performed at different compression ratios for the individual sections in the frequency bands, and more accurate signal processing can be provided. Accordingly, the object sound extraction performance and the musical noise reduction performance can be increased.

Further, the processings performed in the individual sections in the above-described object sound extraction apparatus can be realized as an object sound extraction method implemented by a computer.

In the aspect of the present invention, under an acoustic environment where different noises arrive at each main microphone from a plurality of directions, or an acoustic environment where an acoustic signal mixes in any of the sub microphones at a relatively large volume, further, in a case where the acoustic environment may change, a high noise removal performance can be ensured.

Further, in the aspect of the present invention, when a volume of a noise sound is large, removal of the signal component of the noise sound is prioritized. When the volume of the noise sound is small, reduction of a musical noise is given priority to the removal of the signal component of the noise sound. Accordingly, the musical noise annoying the audience can be reduced.

### BRIEF DESCRIPTION OF THE DRAWINGS

FIG. 1 is a block diagram illustrating a schematic configuration of an object sound extraction apparatus X1 according to a first embodiment of the present invention;

FIG. 2 is a block diagram illustrating a schematic configuration of an object sound extraction apparatus X2 according to a second embodiment of the present invention;

FIG. 3 is a block diagram illustrating a schematic configuration of an object sound extraction apparatus X3 according to a third embodiment of the present invention;

FIG. 4 is a view illustrating an example of a relationship between levels of reference sound corresponding signals and compression coefficients in a spectrum subtraction processing in the object sound extraction apparatuses X1 to X3;

FIG. 5 is a view illustrating an example of a relationship between levels of reference sound corresponding signals and subtraction amounts in spectrum subtraction processings in the object sound extraction apparatuses X1 to X3;

FIG. 6 is a view illustrating an example of a relationship between levels of reference sound corresponding signals and compression ratios in spectrum subtraction processings in the object sound extraction apparatuses X1 to X3; and

FIG. 7 is a block diagram illustrating a schematic configuration of a sound source separation apparatus Z that performs a sound source separation processing based on the BSS method based on the FDICA.

Embodiments of the invention will be described in detail below with reference to the drawings to enhance the understanding of the present invention. It is to be understood that the following embodiments are examples of embodiments of the present invention, and the technical scope of the invention is not limited to the disclosed embodiments.

### DESCRIPTION OF THE PREFERRED EMBODIMENTS

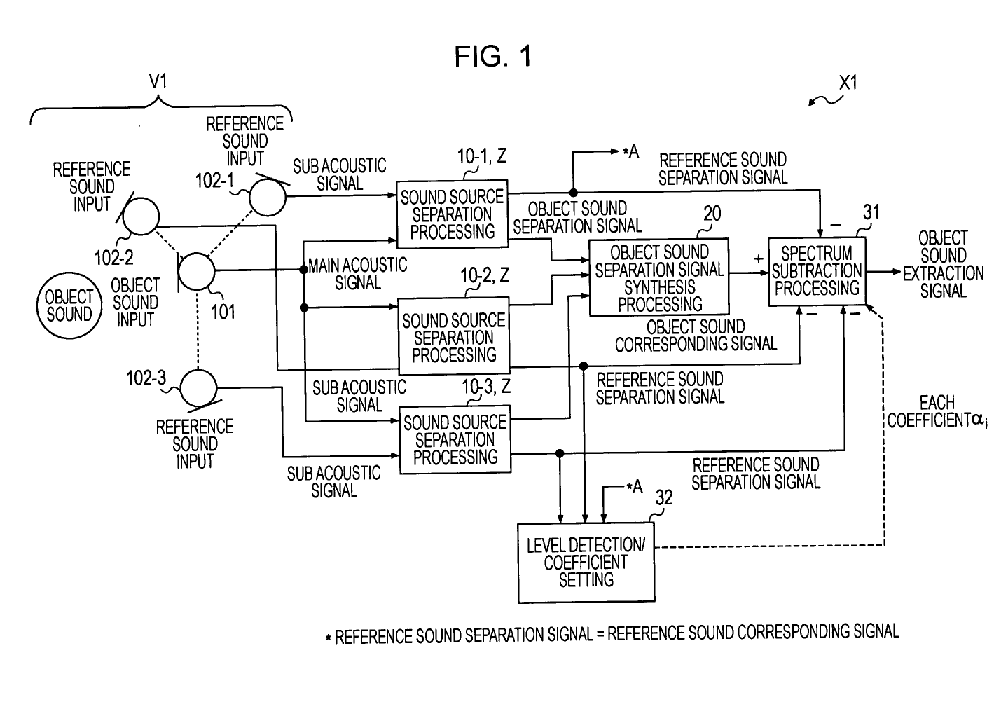

### First Embodiment (See FIG. 1)

First, an object sound extraction apparatus X1 according to a first embodiment of the present invention is described with reference to a block diagram illustrated in FIG. 1.

As illustrated in FIG. 1, the object sound extraction apparatus X1 includes an acoustic input device V1 that has microphones, a plurality of (three in FIG. 1) sound source separation processing sections 10 (10-1 to 10-3), an object sound separation signal synthesis processing section 20, a spectrum subtraction processing section 31, and a level detection/coefficient setting section 32. The acoustic input device V1 includes a main microphone 101 and a plurality of (three in FIG. 1) sub microphones 102 (102-1 to 102-3). The main microphone 101 and the sub microphones 102 are disposed at positions different from each other, or, have directivities in directions different from each other.

The main microphone 101 is an acoustic input section that mainly inputs sound (hereinafter, referred to as object sound) generated by a predetermined object sound source (for example, a speaker who can move in a predetermined area).

The sub microphones 102-1 to 102-3 are disposed at positions different from the position of the main microphone 101 respectively, or, have the directivities in the directions different from each other. The sub microphones are acoustic input sections that mainly input reference sounds (noises) other than the object sound. The expression “sub microphones 102” is a generic term of the sub microphones 102-1 to 102-3.

Each of the main microphone 101 and the sub microphones 102 illustrated in FIG. 1 has a directivity. The sub microphones 102 are disposed so that the sub microphones 102 have directivities in directions different from that of the main microphone 101 respectively.

In a case where each of the main microphone 101 and the sub microphones 102 have each directivity, if a directional central direction (front direction) of the main microphone 101 is a center (0°), it is preferred that directional central directions (front directions) of the sub microphones 102 are set in one direction less than +180° (for example, in a direction of +90), and in the other direction less than −180° (for example, in a direction of −90°) respectively.

The directional directions of the main microphone 101 and the sun microphones 102 may be set in different directions in a plane, or set in three-dimensionally different directions.

The object sound extraction apparatus X1, on the basis of a main acoustic signal obtained via the main microphone 101 and sub acoustic signals obtained via the sub microphones 102 other than the main acoustic signal, extracts an acoustic signal corresponding to the object sound and outputs an extraction signal (hereinafter, referred to as object sound extraction signal).

In the object sound extraction apparatus X1, the sound source separation processing sections 10, the object sound separation signal synthesis processing section 20, the spectrum subtraction processing section 31, and the level detection/coefficient setting section 32 are realized, for example, by Digital Signal Processor (DSP), which is an example of a computer, a read-only memory (ROM) that stores a program implemented by the DSP, an application specific integrated circuit (ASIC), or the like. In such a case, the ROM stores a program for instructing the DSP to implement processing (described below) performed by the sound source separation processing sections 10, the object sound separation signal synthesis processing section 20, the spectrum subtraction processing section 31, and the level detection/coefficient setting section 32 in advance.

The sound source separation processing sections 10 (10-1 to 10-3) are provided for each combination of the main acoustic signal and the sub acoustic signals. On the basis of the combination of the main acoustic signal and the sub acoustic signals, a sound source separation processing is performed. In the sound source separation processing, an object sound separation signal that is a separation signal (identification signal of object sound) corresponding to the object sound and a reference sound separation signal (identification signal of reference sound) corresponding to the reference sounds (can be referred to as noises) that are the sounds other than the object sound are separated and generated (an example of the sound source separation section). Hereinafter, in the first embodiment of the present invention, the reference sound separation signal is also referred to as a reference sound corresponding signal. In the first embodiment of the present invention, the reference sound separation signal is the same as the reference sound corresponding signal.

Between the main microphone 101 and the sub microphones 102, and the sound source separation processing sections 10, analog-digital converters (A/D converters, not shown) are provided. Acoustic signals that are converted into digital signals by the A/D converters are transmitted to the sound source separation processing sections 10. For example, if the object sound is a human voice, the voice can be digitalized in a sampling period of about 8 kHz.

The sound source separation processing sections 10 (10-1 to 10-3) implement a sound source separation processing according to the ICA-BSS method or the like.

Now, with reference to a block diagram in FIG. 7, a sound source separation device Z that is an example of a device that can be employed as the sound source separation processing sections 10 is described.

The sound source separation device Z described below performs a processing for sequentially generating a plurality of separation signals (signals identified sound source signals) corresponding to sound source signals. In the processing for sequentially generating the separation signals, in a state that a plurality of sound sources and a plurality of microphones 101 and 102 exist in a predetermined acoustic space, in a case where a plurality of mixed sound signals in which individual sound signals (hereinafter, referred to as sound source signals) inputted from each sound source via the microphones 101 and 102 are superimposed are sequentially inputted, the sound source separation processing according to the BSS-ICA method, that is, Frequency-Domain ICA (FDICA), is performed onto the mixed sound signals in the frequency domain to sequentially generate the separation signals corresponding to the sound source signals.

In the FDICA method, first, with respect to an inputted mixed sound signal x(t), Short Time Discrete Fourier Transform (hereinafter, referred to as ST-DFT processing) is performed for each frame that is a signal divided in predetermined periods by a ST-DFT processing section 13 to perform a short time analysis of an observation signal. Then, with respect to the ST-DFT processed signal of each channel (signal of each frequency component), a separation calculation processing based on a separation matrix W(f) is performed by a separation calculation processing section 11f to separate a sound source (identify sound source). If f is a frequency bin, and m is an analysis frame number, a separation signal (identification signal) y(f, m) can be expressed as the following equation (1).

### Equation (1)

Y(f,m)=W(f)·X(f,m) (1)

Here, an updating equation of a separation filter W(f) can be expressed as the following equation (2).

### Equation (2)

W_{(ICA/)}^{[i+1]}(f)=W_{(ICA/)}^{[i]}(f)−η(f)[off-diag{ [symbol] φ(Y_{(ICA/)}^{[i]}(f,m))Y_{(ICA/)}^{[i]}(f,m)^{H} [symbol] ₘ}]W_{(ICA/)}^{[i]}(f) (2)
wherein, η(f) denotes an update coefficient, i denotes the number of updates, < . . . > denotes a time-averaging operator, and H denotes a Hermitian transposition.
off-diag X denotes a calculation processing for replacing all diagonal elements in the matrix X with zero.
φ( . . . ) denotes an appropriate nonlinear vector function that has a sigmoidal function or the like as elements.

According to the FDICA method, the sound source separation processing is considered as an instantaneous mixture in each narrow band, and the separation filter (separation matrix) W(f) can be relatively easily and stably updated.

In FIG. 7, a separation signal y₁(f) corresponding to the main microphone 101 is the object sound separation signal. A separation signal y₂(f) corresponding to the sub microphone 102 is the reference sound separation signal. The reference sound separation signal (separation signal y₂(f)) is an acoustic signal in the frequency domain.

In FIG. 7, the number of channels (that is, the number of microphones) of the mixed sound signals x₁ and x₂ to be inputted is two. However, if (the number of channels n)≧(the number of sound sources m) is satisfied, even if the number of the channels is three or more, the sound source separation operation can be performed by a similar configuration.

The level detection/coefficient setting section 32 (an example of the signal level detection section) implements a processing to detect signal levels (magnitude of value, volume of sound) of individual reference sound separation signals (reference sound corresponding signals) and a processing to set a compression coefficient that is used in a processing performed in the spectrum subtraction processing section 31 based on the detected levels.

For example, the level detection/coefficient setting section 32 detects an average value or a total of signal values (signal values in frequency bins in the reference sound separation signals in the frequency domain) of the frequency spectrums in the individual reference sound separation signals, or a value obtained by normalizing the values by a predetermined reference value as the signal level. Further, it is possible that, with respect to the frequency spectrums of the individual reference sound separation signals, for sections of predetermined frequency bands, the level detection/coefficient setting section 32 detects an average value or a total of signal values of frequency bins in the individual sections, or a value obtained by normalizing the values by a predetermined reference value as the signal level. As the sections in the frequency bands, for example, sections in individual frequency bins in the frequency spectrums or sections defined by combinations of the frequency bines can be used.

When the levels L (detected levels L) that are detected for the individual reference sound separation signals are within a predetermined range, the level detection/coefficient setting section 32 sets the compression coefficient α such that the value becomes small as the detection signal levels L are low. The compression coefficient α (0≦α≦1) is a coefficient used in a spectrum subtraction processing described below. A detailed description of the spectrum subtraction processing will be described below. In FIG. 1, a subscript i of the compression coefficient α denotes an identification number corresponding to each of the reference sound separation signals.

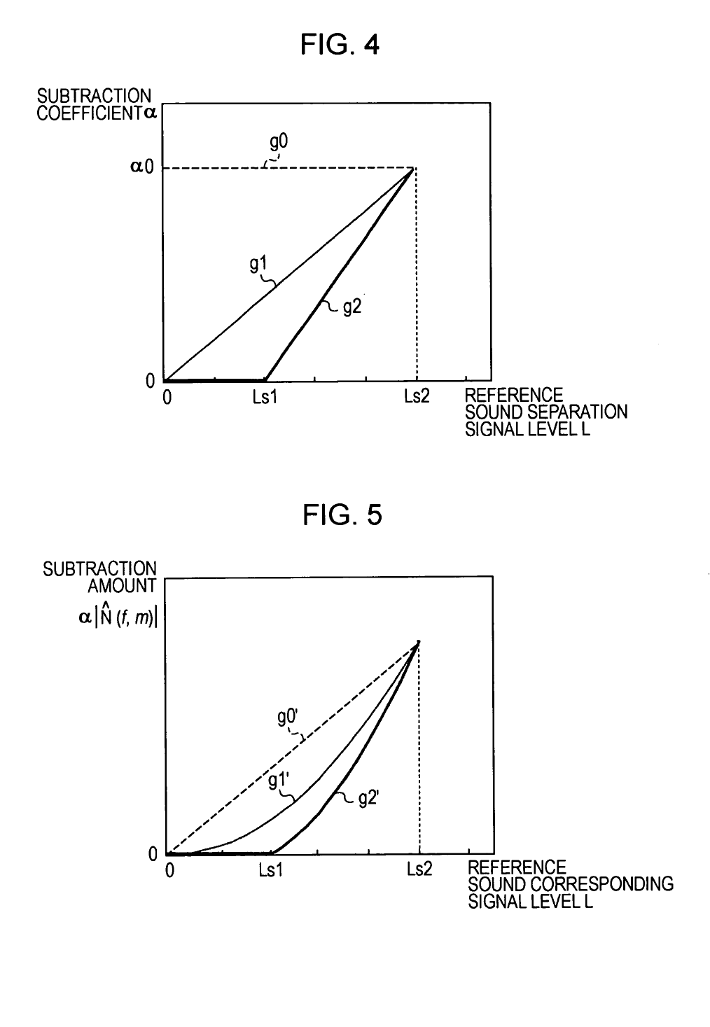

FIG. 4 is a view illustrating an example of a relationship between the detection levels L (horizontal axis) of the reference sound corresponding signals (in the first embodiment, the reference sound separation signals) and the compression coefficients α (vertical axis).

In FIG. 4, a graphic line g1 is an example of a state that when the detection signal level L is within a range 0 or more and Lₛ2 or less, the compression coefficient α that has a positive proportionality relation with respect to the detection level L is set.

In FIG. 4, a graphic line g2 is an example of a state that when the detection signal level L is within a range Lₛ1 (>0)or more and the upper limit Lₛ2 or less, the compression coefficient α that has a positive proportionality relation with respect to the detection level L is set. When the compression coefficient α of the graphic line g2 is set, if the detection signal level L is less than the lower limit level Lₛ1, the compression coefficient α is set to 0 (zero).

The level detection/coefficient setting section 32 sets the compression coefficient α shown as the graphic line g1 or the graphic line g2 depending on the detection signal level L.

For a comparison with the compression coefficient α that is set by the level detection/coefficient setting section 32, in FIG. 4, a graphic line g0 (dashed line) that denotes a state the compression coefficient α is constant irrespective of the detection signal level L.

In the object sound extraction apparatus X1, the object sound separation signal synthesis processing section 20 performs a processing to synthesize the object sound separation signals that are separated and generated by the sound source separation processing sections 10 respectively, and outputs a synthesis signal obtained by the processing. Hereinafter, in the first embodiment, the synthesis signal obtained by synthesizing the object sound separation signals is referred to as an object sound corresponding signal.

For example, with respect to the object sound separation signals, the object sound separation signal synthesis processing section 20 performs an averaging processing or a weighted averaging processing for each frequency component (frequency bin) that is formed by dividing into a plurality of components, or the like to synthesize the object sound separation signals.

Further, in the object sound extraction apparatus X1, the spectrum subtraction processing section 31 performs a spectrum subtraction processing between the object sound corresponding signal (synthesis signal) obtained by the object sound separation signal synthesis processing section 20 and the reference sound separation signals separated and generated by the sound source separation sections 10 respectively to extract an acoustic signal corresponding to the object sound from the object sound corresponding signal and outputs the acoustic signal (the object sound extraction signal).

Hereinafter, a specific example of the processing performed by the spectrum subtraction processing section 31 is described.

If a spectrum value of an observation signal, which is an acoustic signal in a frequency domain, that is, a spectrum value (signal value in each frequency bin in a frequency spectrum) of the object sound corresponding signal (in the first embodiment, the signal obtained by synthesizing the object sound separation signals) is Y(f, m), a spectrum value of an object sound signal is S(f, m), and a spectrum value of a noise signal (signal of a sound other than the object sound) is N(f, m), the spectrum value Y(f, m) of the observation signal is expressed as following equation (3).

### Equation (3)

Y(f,m)=S(f,m)+N(f,m) (3)
wherein, f denotes the frequency bin, m denotes the analysis frame number,
Y(f, m) denotes the spectrum value of the object sound corresponding signal (observation signal),
S(f, m) denotes the spectrum value of the object sound signal,
N(f, m) denotes the spectrum value of the noise signal.

In the object sound extraction apparatus X1, it is assumed that there is no correlation between the object sound signal and the noise signal, and further, the spectrum value N(f, m) of the noise signal can be approximated by the spectrum value of the reference sound corresponding signal. Then, a spectrum estimation value (that is, a spectrum value of the object sound extraction signal) of the object sound signal can be calculated (extracted) by the following equation (4).

### Equation (4)

$$\vert \hat{S} ( f , m ) \vert = \{ \begin{matrix}\vert Y ( f , m ) \vert - α \vert \hat{N} ( f , m ) \vert & if \vert Y ( f , m ) \vert > α \vert \hat{N} ( f , m ) \vert \\ β \vert Y ( f , m ) \vert & otherwise\end{matrix} \qquad ( 4 )$$

### Wherein,

   |Ŝ(f,m)| denotes the spectrum estimation value of the object sound signal,
   |\hat{N}(f,m)| denotes the spectrum approximation value (spectrum value of the reference sound corresponding signal) of the noise signal,
α denotes a compression coefficient: 0≦α, and β denotes a suppression coefficient: 0≦β<1

The compression coefficient α in the equation is a coefficient set to correspond to the detection signal level L by the level detection/coefficient setting section 32. Further, in the equation 4, the terms where the compression coefficient α is multiplied by the spectrum value of the reference sound corresponding signal are terms where operations to compress and correct the spectrum value of the reference sound corresponding signal by the compression coefficient α.

Normally, the suppression coefficient β in the equation 4 is set to 0 (zero) or a very small value close to zero.

FIG. 5 is a view illustrating an example of a relationship between the detection levels L (horizontal axis) with respect to the reference sound separation signals (in the drawing, shown as reference sound corresponding signals) that are signals corresponding to the reference sounds and subtraction amounts in a spectrum subtraction processing based on the equation 4. The subtraction amounts are the compressed and corrected spectrum values when it is assumed that the spectrum values of the reference sound corresponding signals are proportional to the detection signal levels L.

In FIG. 5, a graphic line g1′ is an example of the subtraction amounts when the compression coefficients α shown by the graphic line g1 in FIG. 4 are set.

In FIG. 5, a graphic line g2′ is an example of the subtraction amounts when the compression coefficients α shown by the graphic line g2 in FIG. 4 are set.

In FIG. 5, a graphic line g0′ is an example of the subtraction amounts when the compression coefficients α are constant (the graphic line g0 in FIG. 4).

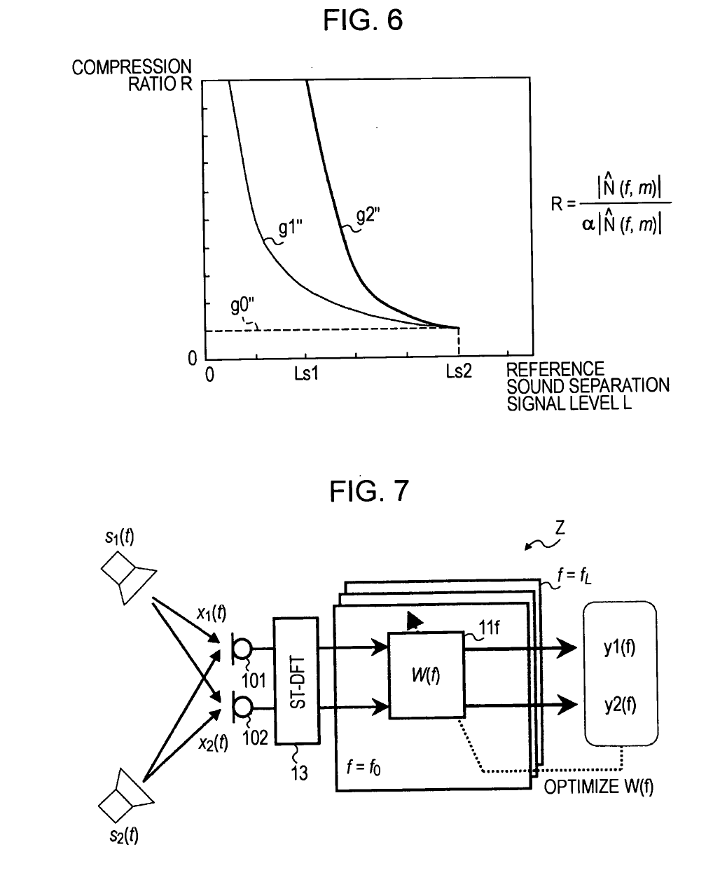

FIG. 6 is a view illustrating an example of a relationship between the detection levels L (horizontal axis) with respect to the reference sound separation signals (in the drawing, shown as reference sound corresponding signals) that are signals corresponding to the reference sounds and compression ratios R in a compression correction of the spectrums of the reference sound corresponding signal (the reference sound separation signals) performed in a spectrum subtraction processing. The compression ratios are ratios (that is, R=1/α) of the signal values before the compression and correction to the signal values (compression amounts in FIG. 4) after the compression and correction.

As shown in FIG. 6, in the object sound extraction apparatus X1, when the detection level is within a predetermined range (for example, 0 to Lₛ2, or Lₛ1 to Lₛ2), the compression coefficient α is set such that as the detection signal level L becomes low, the value of the compression coefficient α becomes small (see FIG. 4). Accordingly, within the predetermined range, the spectrum subtraction processing section 31 compresses and corrects the frequency spectrum of the reference sound corresponding signal at a large compression ratio R as the detection signal level L becomes low. The predetermined range can be all ranges the detection signal levels are available.

The processing performed in the spectrum subtraction processing section 31 based on the compression coefficient α can be summarized as the following processing.

That is, in the processing performed in the spectrum subtraction processing section 31 (an example of the spectrum subtraction processing section), when the detection signal level L is at a level within the predetermined range (for example, 0 to Lₛ2, or Lₛ1 to Lₛ2), the frequency spectrums of the individual reference sound corresponding signals are compressed and corrected at large compression ratios R as the object sound detection signal levels L become low respectively. From the frequency spectrum of the object sound corresponding signal obtained by performing the sound source separation processing and the synthesis processing on the main acoustic signal, the frequency spectrums obtained by the compression and correction are subtracted. Then, from the object sound corresponding signal, the acoustic signal corresponding to the object sound is extracted from the object sound corresponding signal and the acoustic signal (the object sound extraction signal) are outputted.

Further, if the compression coefficient α shown by the graphic line g2 is set, in a case where the detection signal level L is the lower limit level Lₛ1 or more, the spectrum subtraction processing section 31 outputs the signal obtained by the subtraction processing of the frequency spectrum as the object sound extraction signal. In a case where the detection signal level L is less than the lower limit level Lₛ1, the compression coefficient α is set to zero. Then, the spectrum subtraction processing section 31 directly outputs the object sound corresponding signal as the object sound extraction signal (acoustic signal corresponding to the object sound) (an example of the object sound corresponding signal outputting section).

By the above-described processing performed in the spectrum subtraction processing section 31, when the level L of the reference sound corresponding signal is high (that is, the volume of the noise sound is large), the signal component annoying the audience can be actively removed form the object sound corresponding signal, and the acoustic signal corresponding to the object sound can be faithfully extracted as much as possible. As a result of the processing, the acoustic signal (the object sound extraction signal) can contain some musical noises. However, as compared to a state where the signal component of the noise sound remains, the acoustic signal is friendlier to the audience.

In the spectrum subtraction processing in which the compression coefficient α is a constant value (graphic line g0 in FIG. 4), the acoustic signal (the object sound extraction signal) tends to contain a musical noise. However, in the processing performed in the spectrum subtraction processing section 31, when the level L of the reference sound corresponding signal is low, (that is, the volume of the noise sound is small), the compression coefficient α is set to a small value and the processing to remove the signal component form the object sound corresponding signal, and the acoustic signal corresponding to the object sound is not actively performed. By the processing the musical noise annoying the audience can be reduced. As a result of the processing, the object sound extraction signal can contain some signal components of the musical noise. However, the signal level (sound volume) is small and the audience hardly notices the noise sound. That is, in the first embodiment of the present invention, when the volume of the noise sound is large, the removal of the signal component of the noise sound is prioritized. When the volume of the noise sound is small, the reduction of the musical noise is given priority to the removal of the signal component of the musical noise.

Accordingly, in the object sound extraction apparatus X1, in the state where a specific noise sound (non-object sound) and a plurality of noise sounds that exist in different directions arrive at the main microphone at relatively high levels, an acoustic signal corresponding to an object sound can be faithfully extracted (reproduced) as much as possible and a musical noise annoying the audience can be reduced.

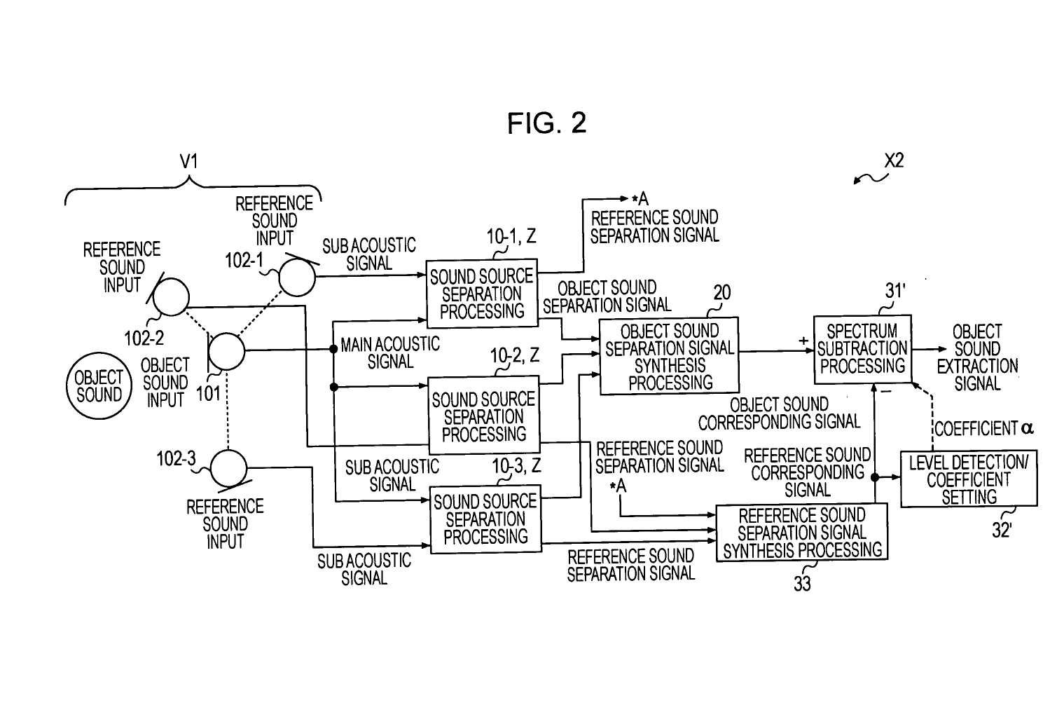

### Second Embodiment (See FIG. 2)

Now, an object sound extraction apparatus X2 according to a second embodiment of the present invention is described with reference to a block diagram illustrated in FIG. 2. In FIG. 2, in structural elements included in the object sound extraction apparatus X2, to structural elements that perform same processings as in the object sound extraction apparatus X1, same reference numerals as those in FIG. 1 are applied.

As illustrated in FIG. 2, similarly to the object sound extraction apparatus X1, the object sound extraction apparatus X2 includes the acoustic input device V1 that has the microphones, the plurality of (three in FIG. 2) sound source separation processing sections 10 (10-1 to 10-3), and the object sound separation signal synthesis processing section 20. The elements are the same as those in the object sound extraction apparatus X1.

Further, the object sound extraction apparatus X2 includes a spectrum subtraction processing section 31′, a level detection/coefficient setting section 32′, and a reference sound separation signal synthesis section 33.

In the object sound extraction apparatus X2, the sound source separation processing sections 10, the object sound separation signal synthesis processing section 20, the spectrum subtraction processing section 31′, and the level detection/coefficient setting section 32′ can be realized, for example, by a DSP, which is an example of a computer, and a ROM that stores a program implemented by a DSP, or an ASIC. In such a case, the ROM stores a program for instructing the DSP to implement processing performed by the sound source separation processing sections 10, the object sound separation signal synthesis processing section 20, the spectrum subtraction processing section 31′, and the level detection/coefficient setting section 32′ in advance.

The object sound extraction apparatus X2 extracts an acoustic signal corresponding to the object sound based on a main acoustic signal obtained via the main microphone 101 and sub acoustic signals obtained via the sub microphones 102 other than the main acoustic signal, and outputs the acoustic signal (the object sound extraction signal).

In the object sound extraction apparatus X2, the reference sound separation signal synthesis section 33 performs a processing to synthesize the reference sound separation signals that are separated and generated by the sound source separation processing sections 10 respectively, and outputs a synthesis signal obtained by the processing. Hereinafter, in the second embodiment, the synthesis signal obtained by synthesizing the reference sound separation signals is referred to as a reference sound corresponding signal.

For example, with respect to the reference sound separation signals, the reference sound separation signal synthesis section 33 performs an averaging processing or a weighted averaging processing for each frequency component (frequency bin) that is formed by dividing into a plurality of components, or the like to synthesize the reference sound separation signals.

The level detection/coefficient setting section 32′ in the object sound extraction apparatus X2 implements a processing to detect signal levels (magnitude of value, volume of sound) of the reference sound corresponding signals (synthesis signal) obtained by the reference sound separation signal synthesis section 33 and a processing to set the compression coefficient α that is used in a processing performed in the spectrum subtraction processing section 31′ corresponding to the detected levels (an example of the signal level detection section). The processing contents are similar to those in the level detection/coefficient setting section 32.

In the object sound extraction apparatus X2, the spectrum subtraction processing section 31′ performs a spectrum subtraction processing between the object sound corresponding signal (synthesis signal) obtained by the object sound separation signal synthesis processing section 20 and the reference sound corresponding signals (synthesis signals) obtained by the reference sound separation signal synthesis section 33 to extract an acoustic signal corresponding to the object sound from the object sound corresponding signal and outputs the acoustic signal (the object sound extraction signal). The processing contents are similar to those in the spectrum subtraction processing section 31.

The object sound extraction apparatus X2 described above can obtain effects similar to those in the object sound extraction apparatus X1. The object sound extraction apparatus X2 is an example of the second embodiment of the present invention.

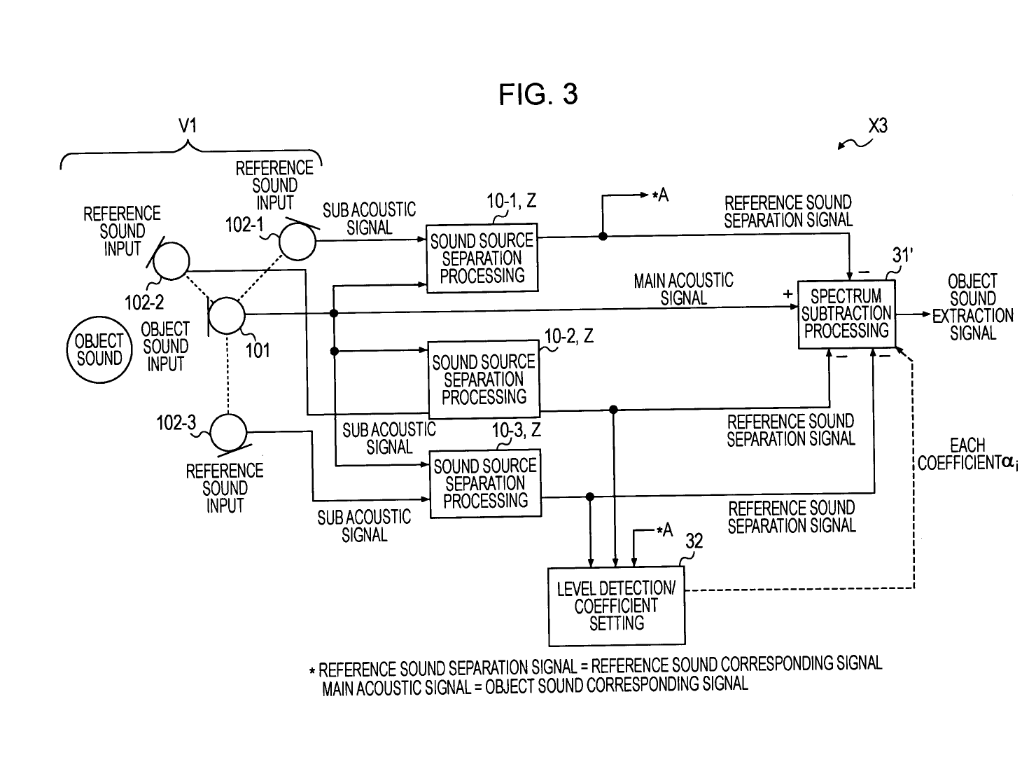

### Third Embodiment (See FIG. 3)

Now, an object sound extraction apparatus X3 according to a third embodiment of the present invention is described with reference to a block diagram illustrated in FIG. 3. In FIG. 3, in structural elements included in the object sound extraction apparatus X3, to structural elements that perform same processings as in the object sound extraction apparatus X1, same reference numerals as those in FIG. 1 are applied.

As illustrated in FIG. 3, the object sound extraction apparatus X3 includes the acoustic input device V1 that has the microphones, the plurality of (three in FIG. 3) sound source separation processing sections 10 (10-1 to 10-3), the spectrum subtraction processing section 31′, and the level detection/coefficient setting section 32. The acoustic input device V1, the sound source separation processing sections 10, and the level detection/coefficient setting section 32 are the same as those provided in the object sound extraction apparatus X1. However, the sound source separation processing sections 10 in the object sound extraction apparatus X3 are not required to output the object sound separation signals.

The object sound extraction apparatus X3 extracts an acoustic signal corresponding to the object sound based on a main acoustic signal obtained via the main microphone 101 and sub acoustic signals obtained via the sub microphones 102 other than the main acoustic signal, and outputs the extraction signal (the object sound extraction signal).

In the object sound extraction apparatus X3, the acoustic input device V1, the sound source separation processing sections 10, the spectrum subtraction processing section 31′, and the level detection/coefficient setting section 32 can be realized, for example, by a DSP, which is an example of a computer, and a ROM that stores a program implemented by a DSP, or an ASIC. In such a case, the ROM stores a program for instructing the DSP to implement processing performed by the sound source separation processing sections 10, and the spectrum subtraction processing section 31′ in advance.

In the object sound extraction apparatus X3, the spectrum subtraction processing section 31′ performs a spectrum subtraction processing between the main acoustic signal (corresponding to the object sound corresponding signal) obtained via the main microphone 101 and the reference sound separation signals (corresponding to the reference sound corresponding signals) separated and generated by the sound source separation processing sections 10 respectively to extract an acoustic signal corresponding to the object sound from the object sound corresponding signal and outputs the acoustic signal (the object sound extraction signal).

That is, the spectrum subtraction processing section 31′ in the object sound extraction apparatus X3 performs the subtraction processing of the frequency spectrums similar to the processing performed in the spectrum subtraction processing section 31 in the object sound extraction apparatus X1. However, the spectrum subtraction processing section 31′ differs from the spectrum subtraction processing section 31 in that the spectrum subtraction processing section 31′ subtracts the frequency spectrums obtained by the compression-correction processing with respect to the individual reference sound separation signals from the frequency spectrum of the main acoustic signal (an example of the object sound corresponding signal).

In the object sound extraction apparatus X3, the object sound corresponding signal to be spectrum-subtracted is the main acoustic signal on which the sound source separation processing is not performed, that is, the main acoustic signal contains a signal component of a relatively large noise sound. Accordingly, normally, the compression coefficient α in the object sound extraction apparatus X3 is set to a value (value close to 1) larger than the compression coefficient α.

The object sound extraction apparatus X3 described above can obtain effects similar to those in the object sound extraction apparatus X1. The object sound extraction apparatus X3 is an example of the third embodiment of the present invention.

In FIG. 6, the compression coefficients α shown by graphic lines g1″ and g2″ have positive proportional relationship (relationship expressed by a primary expression) with the detection signal levels L when the detection signal levels L are within a predetermined range (0 to Lₛ2, or Lₛ1 to Lₛ2). However, the relationship between the detection signal levels L and the compression coefficients α can be a non-linear relationship expressed by a second-order polynomial or a third-order polynomial.

In the sound source separation processing sections 10 (for example, sound source separation processing based on the FDICA), a sound source separation processing to process three or more acoustic signals can be performed. For example, one main acoustic signal and three sub acoustic signals are inputted and one object sound separation signal and three reference sound separation signals are outputted. That is, in the object sound extraction apparatuses X1 to X3, using one sound source separation processing section 10, one object sound separation signal and a plurality of reference sound separation signals can be separated and generated.

In the above-described embodiments, the object sound extraction apparatuses X1 to X3 have a plurality of sub microphones 102. However, embodiments (hereinafter, referred to as object sound extraction apparatuses X1′, X2′, and X3′) that each of the object sound extraction apparatuses X1 to X3 has one main microphone 101 and one sub microphone 102 that is disposed at a position different from the main microphone 101 and has a directivity different from the main microphone 101 can be provided.

For example, the object sound extraction apparatuses X1′ that is a first embodiment has a configuration that from the configuration of the object sound extraction apparatuses X1 illustrated in FIG. 1, the two sub microphones 102-2 and 102-3, the two sound source separation processing sections 10-2 and 10-3, and the object sound separation signal synthesis processing section 20 are omitted. In such a case, the object sound separation signal obtained by the sound source separation processing section 10-1 is the object sound corresponding signal to be processed by the spectrum subtraction processing section 31.

The object sound extraction apparatuses X2′ that is a second embodiment has a configuration that from the configuration of the object sound extraction apparatuses X2 illustrated in FIG. 2, the two sub microphones 102-2 and 102-3, the two sound source separation processing sections 10-2 and 10-3, the object sound separation signal synthesis processing section 20, and the reference sound separation signal synthesis section 33 are omitted. In such a case, the object sound separation signal and the reference sound separation signal obtained by the sound source separation processing section 10-1 are the object sound corresponding signal and the reference sound corresponding signal to be processed by the spectrum subtraction processing section 31.

Further, the object sound extraction apparatuses X3′ that is a third embodiment has a configuration that from the configuration of the object sound extraction apparatuses X3 illustrated in FIG. 3, the two sub microphones 102-2 and 102-3, and the two sound source separation processing sections 10-2 and 10-3 are omitted.

The above-described object sound extraction apparatuses X1′ to X3′ constitute the embodiments of the present invention.

In the above-described embodiments, in the object sound extraction apparatuses X1 and X2 (FIG. 1 and FIG. 2), the example that the signal obtained by performing the sound source separation processing based on the main acoustic signal and the sub acoustic signals and the synthesis processing to synthesize the object sound separation signals obtained by the sound source separation processing is to be the object sound corresponding signal to be processed in the spectrum subtraction processing. However, it is not limited to the example, an acoustic signal that is synthesized by performing a weighted-synthesis processing on the main acoustic signal and the sub acoustic signals can be used as the object sound corresponding signal (signal to be spectrum-subtraction processed). In the weighted-synthesis processing, a weight to the main acoustic signal can be larger than a weight to the sub acoustic signals.

In the above-described embodiments, the example that in the object sound extraction apparatus X2 (FIG. 2), the level detection/coefficient setting section 32′ detects a level of the signal obtained by synthesizing the reference sound separation signals has been described. However, it is not limited to the above, in the object sound extraction apparatus X2, the level detection/coefficient setting section 32′ can detect signal levels of the individual reference sound separation signals, and on the basis of the detected signal levels (for example, on the basis of an average level, a total level of the signal levels or the like), and set the compression coefficient α.

The present invention can be applied to object sound extraction apparatuses that extract an acoustic signal corresponding to an object sound from acoustic signals containing an object sound component and a noise sound component and extract the extraction signal.

What is claimed is:

1. An object sound extraction apparatus comprising:
a main sound input section for mainly inputting an object sound generated by a predetermined object sound source and outputting a main acoustic signal;
sub sound input sections for mainly inputting one or more reference sounds generated by one or more sound sources other than the object sound source and outputting one or more sub acoustic signals;
a sound source separation section for performing a sound source separation processing for separating and generating one or more reference sound separation signals corresponding to the one or more reference sounds on the basis of the main acoustic signal and the one or more sub acoustic signals;
a signal level detection section for detecting a signal level of the reference sound separation signal or a reference sound corresponding signal that is a synthesis signal obtained by synthesizing the reference sound separation signals;
a spectrum subtraction processing section for extracting an acoustic signal corresponding to the object sound from an object sound corresponding signal and outputting the acoustic signal when the detected signal level is within a predetermined range by compressing and correcting a frequency spectrum of the reference sound corresponding signal at a large compression ratio as the detected signal level becomes small, and subtracting a frequency spectrum of the reference sound corresponding signal obtained by the compression and correction from a frequency spectrum of the main acoustic signal or the object sound corresponding signal obtained by performing a predetermined signal processing on the main acoustic signal.

2. The object sound extraction apparatus according to claim 1, further comprises an object sound corresponding signal outputting section for outputting the object sound corresponding signal as an acoustic signal corresponding to the object sound when the detected signal level is at a level less than a predetermined lower limit level,
wherein, the spectrum subtraction processing section outputs a signal obtained by the frequency spectrum subtraction processing as an acoustic signal corresponding to the object sound when the detected signal level is at the lower limit level or more.

3. The object sound extraction apparatus according to claim 1, wherein the sound source separation section performs a sound source separation processing for separating and generating an object sound separation signal and the reference sound separation signals on the basis of combinations of the main acoustic signal and the individual sub acoustic signals,
the signal level detection section detects signal levels of the individual reference sound separation signals, and
the spectrum subtraction processing section performs the compression and correction on the individual reference sound separation signals, and subtracts frequency spectrums obtained by performing the compression and correction on the individual reference sound separation signals from a frequency spectrum of the object sound corresponding signal obtained by synthesizing the object sound separation signals.

4. The object sound extraction apparatus according to claim 1, wherein the sound source separation section performs a sound source separation processing for separating and generating an object sound separation signal and the reference sound separation signals on the basis of combinations of the main acoustic signal and the individual sub acoustic signals,
the signal level detection section detects a signal level of the reference sound corresponding signal obtained by synthesizing the reference sound separation signals, and
the spectrum subtraction processing section subtracts a frequency spectrum obtained by performing the compression and correction on the reference sound corresponding signal obtained by synthesizing the reference sound separation signals from a frequency spectrum of the object sound corresponding signal obtained by synthesizing the object sound separation signals.

5. The object sound extraction device according to claim 1, wherein the signal level detection by the signal level detection section and the compression and correction by the sound source separation section are performed for individual sections in predetermined frequency bands.

6. The object sound extraction device according to claim 1, wherein the sound source separation section performs a sound source separation processing based on a blind source separation method based on an independent component analysis performed on an acoustic signal in a frequency domain.

7. An object sound extraction method comprising:
a main sound input processing for mainly inputting an object sound generated by a predetermined object sound source and outputting a main acoustic signal;
sub sound input processings for mainly inputting one or more reference sounds generated by one or more sound sources other than the object sound source and outputting one or more sub acoustic signals;
a sound source separation processing for performing a sound source separation processing for separating and generating an object sound separation signal corresponding to the object sound and one or more reference sound separation signals corresponding to the one or more reference sounds on the basis of the main acoustic signal and the one or more sub acoustic signals;
a signal level detection processing for detecting a signal level of the reference sound separation signal or a reference sound corresponding signal that is a synthesis signal obtained by synthesizing the reference sound separation signals;
a spectrum subtraction processing for extracting an acoustic signal corresponding to the object sound from an object sound corresponding signal and outputting the acoustic signal when the detected signal level is within a predetermined range by compressing and correcting a frequency spectrum of the reference sound corresponding signal at a large compression ratio as the detected signal level becomes small, and subtracting a frequency spectrum of the reference sound corresponding signal obtained by the compression and correction from a frequency spectrum of the main acoustic signal or the object sound corresponding signal obtained by performing a predetermined signal processing on the main acoustic signal.
